(19) United States
(12) Patent Application Publication
(10) Pub. No.: US 2013/0129434 A1
(43) Pub. Date: May 23, 2013

(54) Cutting Insert and Indexable Rotary Cutting Tool

(71) Applicant: Kedar Suresh Bhagath, Iwaki-shi (JP)

(72) Inventor: Kedar Suresh Bhagath, Iwaki-shi (JP)

(73) Assignee: Tungaloy Corporation, Iwaki-shi (JP)

(21) Appl. No.: 13/739,910

(22) Filed: Jan. 11, 2013

Related U.S. Application Data
(63) Continuation-in-part of application No. PCT/JP2012/059856, filed on Apr. 11, 2012.

(30) Foreign Application Priority Data
Apr. 25, 2011 (JP) 2011-097343

(51) Int. Cl. B23C 5/20; B23C 5/08

(52) U.S. Cl. CPC B23C 5/207; B23C 5/08; B23C 5/205
USPC 407/51; 407/114; 407/113

(57) ABSTRACT

A cutting insert is arranged in a tangential direction on an outer peripheral portion of a tool body, the cutting insert having a reduced area in a top view thereof. The cutting insert has an upper face, a lower face and at least five side faces extending between the upper and lower faces. The upper face of the cutting insert has at least five intersection portions intersecting with the at least five side faces. The at least five intersection portions include first and second intersection portions and third and fourth intersection portions shorter than the first and second intersection portions, respectively. A cutting edge is formed at each of the first and second intersection portions. A rake face is formed on cutting side faces corresponding to the first and second intersection portions, respectively, while a cutting edge flank is formed on the upper face.

### CROSS-REFERENCE TO RELATED APPLICATIONS

This is a continuation-in-part of PCT application No. PCT/JP2012/059856, filed Apr. 11, 2012, which claims the benefit of Japanese Patent Application 2011-097343, filed Apr. 25, 2011. The contents of the aforementioned applications are hereby incorporated by reference in their entirety.

### BACKGROUND OF THE INVENTION

1. Field of the Invention

The present invention relates to a cutting insert and an indexable rotary cutting tool to which the cutting insert is attached. More specifically, the present invention relates to a cutting insert used for slot machining and an indexable rotary cutting tool for slot machining.

2. Description of the Related Art

As one of rotary cutting tools capable of slot machining, an indexable side cutter is known. In a plate-like cutting insert to be attached to the indexable side cutter, there are known a type in which either of upper and lower faces is used as a rake face and is arranged on an outer peripheral surface of a disk-shaped cutting tool body in a radial direction and a type in which a side face is used as a rake face and is arranged on an outer peripheral surface of a disk-shaped tool body in a tangential direction of the circumference. The type arranged in the radial direction is also called a lay-down type. The type arranged in the tangential direction is also called a tangential type.

A cutting insert of the type arranged in the radial direction is disclosed in Japanese Patent Laid-Open No. H06-31579 (1994), for example. Such cutting insert is attached to an insert seat portion facing forward in a tool rotating direction in a chip pocket. In general, the cutting insert is screwed to a tool body by using a mounting hole provided in a flat plate surface. Since a space of the chip pocket is small, it takes time and effort to screw this type of cutting insert to the insert seat surface. In order to facilitate the screwing, the size of the chip pocket needs to be increased more than necessary, and in this case, lowered rigidity of the tool body makes a problem.

A cutting insert of the type arranged in the tangential direction is disclosed in, for example, Japanese Patent Laid-Open No. H05-12027 (1993). Since this type of cutting insert is arranged on an end face or an outer peripheral side face of the disk-shaped rotary cutting tool body, screwing is easier than that of the type arranged in the radial direction. Furthermore, due to a difference in the arranging method, a thickness on the rear side in the tool rotating direction of the cutting edge of the cutting insert of the type arranged in the tangential direction (that is, a vertical or horizontal length of the upper face or the lower face of the cutting insert) is formed considerably larger than the thickness on the rear side in the tool rotating direction of the cutting edge of the cutting insert of the type arranged in the radial direction (that is, a height of the side face connecting the upper face and the lower face of the cutting insert), and thus, it has the advantage that damage to the cutting insert by cutting resistance can be greatly suppressed.

Cutting inserts of the type arranged in the tangential direction include a cutting insert 71 having a square outer shape as described in FIG. 7A in general (the cutting insert of Japanese Patent Laid-Open No. H05-12027 (1993) is of this type) and a cutting insert 72 having a triangular outer shape as described in FIG. 7B. As illustrated in FIGS. 7A and 7B, the cutting inserts are attached in the staggered manner as tangentially mounted on the rear side in the tool rotating direction of a chip pocket 73 on the outer peripheral surface of the disk-shaped tool body, respectively. When the cutting insert is to be attached as above, with the triangular cutting insert 72, the number of cutting edges that can be used is only one of the upper faces and one of the lower faces, that is, two in total. In contrast, with the square-shaped cutting insert 71, the benefit is that the number of cutting edges that can be used is two of the upper faces and two of the lower faces, that is, four in total, and thus the square-shaped cutting insert 71 is often used.

### SUMMARY OF THE INVENTION

In the case of the square-shaped cutting insert 71, although the number of usable cutting edges is four, an area on plan view is larger than that of the triangular cutting insert 72. That is, since an area not involved in cutting is small in the triangular cutting insert 72, an area of a back support region 74 of the tool body can be taken large, but in the square-shaped cutting insert 71, since an area not involved in cutting is large, the area of the back support region 74 of the tool body decreases. Therefore, capability of holding the cutting insert lowers as compared with the case where the triangular cutting insert 72 is used. When the holding capability of the cutting insert lowers, chattering or positional shifting of the cutting insert can easily occur and as a result, it is likely that the cutting insert is broken or its finished surface roughness deteriorates.

The present invention provides a cutting insert arranged in the tangential direction on the outer peripheral portion of the tool body, in which an area on top view is reduced, and an indexable rotary cutting tool to which the cutting insert is removably attached.

The cutting insert according to a first aspect of the present invention is a plate-like cutting insert including: an upper face having a substantially polygonal outer shape;

a lower face opposite to the upper face;

a plurality of side faces extending between the upper face and the lower face; and

a mounting hole penetrating from the upper face to the lower face, wherein:

the upper face comprises at least five intersection portions intersecting with the plurality of side faces;

a first intersection portion and a second intersection portion are arranged at positions adjacent to each other;

a third intersection portion is arranged at a position adjacent to the first intersection portion;

a fourth intersection portion is arranged at a position adjacent to the second intersection portion;

the third and fourth intersection portions comprise lengths shorter than the first and second intersection portions, respectively;

on the first and second intersection portions, a cutting edge is formed, respectively;

on the plurality of side faces, a rake face is formed on the side face corresponding to the first and second intersection portions, respectively; and

on the upper face, a flank for forming a cutting edge is formed.

In the above configuration, there can be employed a cutting insert which is configured such that, in the at least five intersection portions, the fifth intersection portion, excluding the first and second intersection portions and the third and fourth intersection portions, is arranged at a position adjacent to at least either one of the third and the fourth intersection portions, and a cutting edge is formed on the fifth intersection portion;

a rake face is formed on the side face corresponding to the fifth intersection portion; and

a flank for forming a cutting edge of the fifth intersection portion is formed on the upper face.

The indexable rotary cutting tool according to the first aspect of the present invention includes:

a disk-shaped tool body defining opposing first and second end faces and an outer peripheral surface extending between the first and second end faces;

a plurality of insert seat portions formed in the peripheral direction of the outer peripheral surface;

a plurality of chip pockets provided on the front side of a tool rotating direction with respect to each of the plurality of insert seat portions; and

a plurality of the cutting inserts according to claim 1 attached to each of the plurality of insert seat portions, wherein

the plurality of insert seat portions arranges the plurality of cutting inserts so that the cutting edge of the first intersection portion and the cutting edge of the second intersection portion of the cutting insert are used alternately in the peripheral direction of the tool body.

The indexable rotary cutting tool according to a second aspect of the present invention includes: a disk-shaped tool body defining opposing first and second end faces and an outer peripheral surface extending between the first and second end faces;

a plurality of insert seat portions formed in the peripheral direction of the outer peripheral surface;

a plurality of chip pockets provided on the front side of the tool rotating direction with respect to each of the plurality of insert seat portions; and

a plurality of the cutting inserts according to claim 2 attached to each of the plurality of insert seat portions, wherein

the plurality of insert seat portions comprises first and second seat portions for attaching a pair of the cutting inserts and a third seat portion for attaching the single cutting insert;

the first and second seat portions and the third seat portion are arranged alternately in the peripheral direction of the outer peripheral surface;

the first seat portion arranges the cutting insert closer to the first end face so that the cutting edge of the first intersection portion of the cutting insert is used;

the second seat portion arranges the cutting insert closer to the second end face so that the cutting edge of the second intersection portion of the cutting insert is used; and

the third seat portion arranges the cutting insert substantially at the center between the first and second end faces so that the cutting edge of the at least fifth intersection portion of the cutting insert is used.

The cutting insert according to a third aspect of the present invention is a plate-like cutting insert including: an upper face having a substantially polygonal outer shape, a lower face opposite to the upper face;

a plurality of side faces extending between the upper face and the lower face; and

a mounting hole penetrating from the upper face to the lower face, wherein:

the upper face comprises at least five intersection portions intersecting with the plurality of side faces;

a first intersection portion and a second intersection portion are arranged at positions adjacent to each other;

a third intersection portion is arranged at a position adjacent to the first intersection portion;

a fourth intersection portion is arranged at a position adjacent to the second intersection portion;

the third and fourth intersection portions have lengths shorter than the first and second intersection portions, respectively;

a cutting edge is formed at least on either one of a first side-face intersection portion between the side face corresponding to the first intersection portion and the side face corresponding to either one of the third and fourth intersection portions and a second side-face intersection portion between the side face corresponding to the second intersection portion and the side face corresponding to the other of the third and fourth intersection portions; and

a flank for forming the cutting edge is formed on at least either one of the side faces corresponding to the third and fourth intersection portions.

The indexable rotary cutting tool according to the third aspect of the present invention includes:

a disk-shaped tool body defining opposing first and second end faces and an outer peripheral surface extending between the first and second end faces;

a plurality of insert seat portions formed in the peripheral direction of the outer peripheral surface;

a plurality of chip pockets provided on the front side of the tool rotating direction with respect to each of the plurality of insert seat portions; and

a plurality of cutting inserts described in claim 6 attached to each of the plurality of insert seat portions, wherein

the plurality of insert seat portions include a first seat portion for attaching the single cutting insert and a second seat portion for attaching the single cutting insert;

the first seat portion and the second seat portion are provided alternately in the peripheral direction of the outer peripheral surface;

the first seat portion arranges the cutting insert closer to the first end face so that the cutting edge of either one of the first and second side-face intersection portions of the cutting insert is used and the upper face or the lower face of the cutting insert is exposed to the outside from the first end face; and

the second seat portion arranges the cutting insert closer to the second end face so that the cutting edge of either one of the first and second side-face intersection portions of the cutting insert is used and the upper face or the lower face of the cutting insert is exposed to the outside from the second end face.

According to the present invention, since a large open space can be ensured on a rear face portion of a cutting edge being used for cutting, and thus a back support portion of the tool body can be taken wide. As a result, while the number of cutting edges larger than that of the prior-art square-shaped tangential cutting insert is provided, the cutting insert can be fixed and held reliably. The cutting insert which is rarely broken and excellent in finished surface roughness and the cutting tool can be provided.

Further features of the present invention will become apparent from the following description of exemplary embodiments (with reference to the attached drawings).

### BRIEF DESCRIPTION OF THE DRAWINGS

FIG. 1A is a top view illustrating a cutting insert according to a first embodiment of the present invention;

FIG. 1B is a perspective view of the cutting insert in FIG. 1A;

FIG. 2A is a plan view illustrating a rotary cutting tool to which the cutting insert in FIG. 1A is attached;

FIG. 2B is a perspective view of the rotary cutting tool in FIG. 2A;

FIG. 2C is a side view of the rotary cutting tool in FIG. 2A;

FIG. 3 is a perspective view illustrating a cutting insert according to a second embodiment of the present invention;

FIG. 4A is a plan view illustrating a rotary cutting tool to which the cutting insert in FIG. 3 is attached;

FIG. 4B is a perspective view of the rotary cutting tool in FIG. 4A;

FIG. 4C is a side view of the rotary cutting tool in FIG. 4A;

FIG. 5 is a perspective view illustrating a cutting insert according to a third embodiment of the present invention;

FIG. 6A is a plan view illustrating a rotary cutting tool to which the cutting insert in FIG. 5 is attached;

FIG. 6B is a perspective view of the rotary cutting tool in FIG. 6A;

FIG. 6C is a side view of the rotary cutting tool in FIG. 6A;

FIG. 7A illustrates a rotary cutting tool to which a prior art cutting insert is attached and

FIG. 7B illustrates a rotary cutting tool to which a prior art cutting insert is attached.

### DETAILED DESCRIPTION

Hereinafter, embodiments of the present invention will be described in details by referring to the attached drawings.

### First Embodiment

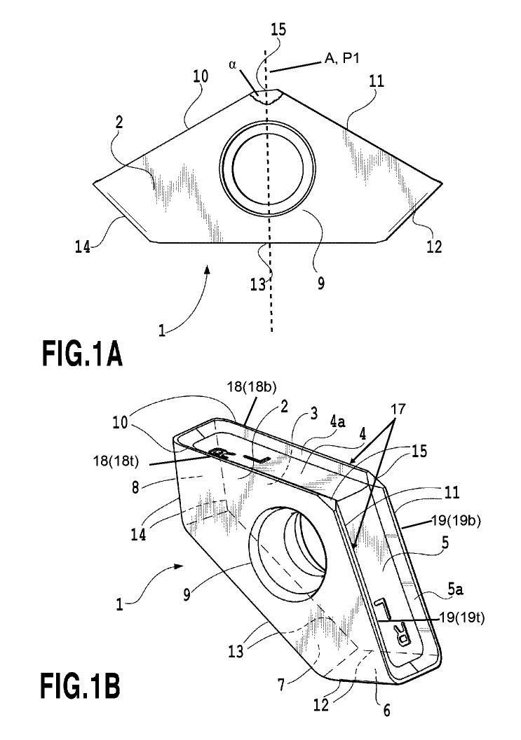

As illustrated in FIG. 1, a cutting insert 1 according to a first embodiment defines an upper face 2 and a lower face 3, each having a polygonal outer shape, a plurality of side faces 4, 5, 6, 7, and 8 extending between the upper face 2 and the lower face 3, and a mounting hole 9 penetrating from the upper face 2 to the lower face 3. The upper face 2 and the lower face 3 have the same shape and face in opposite directions so as to be substantially parallel to each other. Side faces 4 and 5 can be considered as first and second cutting side faces 4, 5, respectively. Side face 7 can be considered as a central side face 7. Side faces 6 and 8 can be considered as second and first lateral side faces 6, 8, respectively.

The upper face 2 has, as illustrated in FIG. 1A, a bilaterally symmetric outer shape on top view. The lower face 3 also has the bilaterally symmetric outer shape. Here, in the upper face 2, there are five intersection portions 10, 11, 12, 13, and 14 intersecting with five side faces 4, 5, 6, 7, and 8, respectively. In FIG. 1A, in these intersection portions, the intersection portion located on the upper left side is set to the first intersection portion 10, and the intersection portion located on the upper right side adjacent to the first intersection portion 10 via a chamfered portion 15 serving as a connection portion is set to the second intersection portion 11. Moreover, the intersection portion located on the lower left side arranged at a position adjacent to the first intersection portion 10 is set to a third intersection portion 14, and the intersection portion located on the lower right side arranged at a position adjacent to the second intersection portion 11 is set to a fourth intersection portion 12. The intersection portion arranged between the third intersection portion 14 and the fourth intersection portion 12, that is, at a position adjacent to them both is set to a fifth intersection portion 13.

The cutting insert 1 has rotational symmetry about a symmetry axis A passing through the mounting hole 9 and bisecting both the first intersection portion 13 and the chamfered portion 15, in a top view of the cutting insert 1. The cutting insert 1 may also have minor symmetry about a bisector plane P1 which contains the symmetry axis A and is perpendicular to the upper and lower faces 2, 3.

The first intersection portion 10 and the second intersection portion 11 have the same length. The fourth intersection portion 12 and the third intersection portion 14 have the same length. Then, the first intersection portion 10 and the second intersection portion 11 are longer than either of the fourth intersection portion 12 and the third intersection portion 14. In the embodiment, if explanation is made by ignoring the connection portion such as the chamfered portion 15, the outer shapes of the upper face 2 and the lower face 3 are formed having a bilaterally symmetric substantially pentagonal shape, the lengths of the first intersection portion 10 and the second intersection portion 11 are set equal, and the lengths of the fourth intersection portion 12 and the third intersection portion 14 are set equal. However, this is not limiting, and the outer shapes of the upper face 2 and the lower face 3 may have bilaterally asymmetric shapes. The lengths of the first intersection portion 10 and the second intersection portion 11 may be different. The lengths of the fourth intersection portion 12 and the third intersection portion 14 may be also different. What is important is that the lengths of the first intersection portion 10 and the second intersection portion 11 are larger than the lengths of the fourth intersection portion 12 and the third intersection portion 14, respectively. The connection portion may also have any shape. Furthermore, in the embodiment, the case having five intersection portions 10, 11, 12, 13, and 14 will be described, but the insert may have a larger number of portions. Meanwhile, the term “adjacent” used for indicating a positional relationship among the five intersection portions 10, 11, 12, 13, and 14, that is, the relationship between the sides of the substantially polygonal outer shapes is not necessarily limited to the case where the intersection portions are directly connected to each other in this description, but is assumed to include connection via a connection portion such as a chamfered portion.

On the intersection portions 10 and 11 between the upper face 2 or the lower face 3 and the cutting side faces 4 and 5, a cutting edge is formed, respectively. In the embodiment, a cutting edge is formed on the first intersection portion 10 and the second intersection portion 11 in each of the upper face 2 and the lower face 3. In FIG. 1B, the cutting edge is shown generally as 17 and includes cutting edge 18(18t, 18b) associated with intersection portion 10 and cutting edge 19(19t, 19b) associated with intersection portion 11. Cutting edges 18t and 19t are associated with the upper face 2 while cutting edges 18b, 19b are associated with the lower face 3. The first intersection portion 10 and the second intersection portion 11 on which the cutting edge is formed, respectively, may be subjected to honing. Furthermore, a land may be provided adjacent to the cutting edge. On the first and second cutting side faces 4 and 5 corresponding to the first intersection portion 10 and the second intersection portion 11 of the upper face 2 and the lower face 3, rake faces 4a and 5a are formed, respectively. These rake faces 4a and 5a are formed so as to gradually incline toward the inside of the cutting insert 1 from the first intersection portion 10 or the second intersection portion 11. In FIG. 1B, the cutting side faces 4 and 5 are formed flat excluding the inclined rake faces 4a and 5a. It should be noted that the shapes of the cutting side faces 4 and 5 are not limited to that, but each may be constituted by an inclined surface without a flat portion or may be formed of curved surfaces. The upper face 2 and the lower face 3 function as contact surfaces where the cutting insert 1 makes contact with an insert seat portion 24 of a tool body 22 which will be described later and also function as a flank for forming the above-described cutting face. When the upper face 2 is used as a flank, the lower face 3 functions as the contact surface, while when the lower face 3 is used as a flank, the upper face 2 functions as the contact surface.

Preferably, the first intersection portion 10 and the second intersection portion 11 (or an extension of the first intersection portion 10 and an extension of the second intersection portion 11) intersect with each other at a first angle α which is within a range of 75° or more and 150° or less on top view. Furthermore, preferably, the chamfered portion 15 is provided on the connection portion between the first intersection portion 10 and the second intersection portion 11. As to this chamfered portion 15, the shape can be modified as appropriate in accordance with the type of a workpiece to be machined or the shape of a groove. Moreover, the intersection portion between the upper face 2 or the lower face 3 and the second lateral side face 6 or the first lateral side face 8 is preferably subjected to round honing or chamfer honing. The shape of this rounding or chamfering can be modified as appropriate in accordance with the type of the workpiece to be machined or the shape of the groove.

Subsequently, a rotary cutting tool 21 to which the cutting insert 1 of the first embodiment is attached will be described.

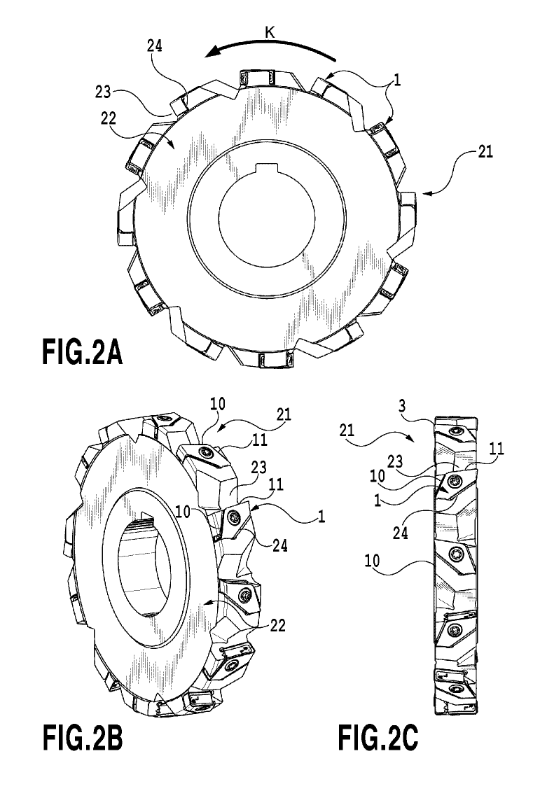

FIGS. 2A-2C illustrate the rotary cutting tool 21 to which the cutting insert 1 of the first embodiment is attached. The tool body 22 is basically constituted by two substantially circular end faces, an outer peripheral surface connecting the two end faces, and a bore penetrating the centers of the two end faces. On the outer peripheral surface of the tool body 22, a chip pocket 23 for discharging the chips and the insert seat portion 24 provided adjacent to the chip pocket 23 on the outer peripheral surface on the rear side in a tool rotating direction K are formed. Each chip pocket has a general V-shape, and a first leg of the V-shape (for supporting the central side face 7) may be longer than a second leg of the V-shape (for supporting one of the lateral side faces 6, 8).

As illustrated in FIGS. 2A to 2C, when the cutting edge 18t or 19t on the upper face 2 of the cutting insert 1 is used, the cutting insert 1 is arranged on the insert seat portion 24 so that the cutting edge 18t of the first intersection portion 10 and the cutting edge 19t of the second intersection portion 11 are used alternately along the peripheral direction (i.e., circumferential direction) of the tool body 22. That is, the cutting insert 1 is arranged with a right hand cutting edge 18t and left hand cutting edge 19t alternately along the peripheral direction of the tool body 22.

When the cutting edge 18b or 19b on the lower face 3 of the cutting insert 1 is to be used, the cutting insert 1 is attached to the tool body 22 so that the cutting edge 19b at the second intersection portion 11 on the lower face 3 is used in the case of right hand, while the cutting edge 18b at the first intersection portion 10 on the lower face 3 is used in the case of left hand. Furthermore, attachment is made such that a part of the side face of the cutting insert 1 substantially coincides with positions of the two end faces of the tool body 22. Moreover, the plurality of inserts 1 are arranged capable of cutting a slot having a width substantially corresponding to the width of the outer peripheral surface of the tool body 22 by collaboration between the cutting edge of the first intersection portion 10 and the cutting edge of the second intersection portion 11.

The action/effect of the rotary cutting tool 21 to which the cutting insert 1 of the first embodiment as described above is attached will be described below.

The cutting insert 1 of the embodiment does not have a square shape, but has two cutting edges for right hand and two cutting edges for left hand, that is, four cutting edges in total. Consequently, as compared with the prior-art square-shaped cutting insert, the back support portion on the rear side in the tool rotating direction K can be made large. Therefore, even under strong cutting resistance, the chattering or breakage of the back support portion is suppressed, and the cutting insert 1 is held firmly. Furthermore, since the cutting resistance applied to the cutting insert 1 can be supported by the holding force in two directions by the central side face 7 and the second lateral side face 6 or by the central side face 7 and the first lateral side face 8 which form a V-shape, the cutting resistance can be received more efficiently and more reliably. Moreover, since an area of the position where the cutting resistance is received (that is, the total area of the central side face 7 and the second lateral side face 6 or the total area of the central side face 7 and the first lateral side face 8) is larger than the area of the position receiving the prior-art square-shaped cutting insert, the holding force per unit area can be reduced. In addition, since the distance between the first intersection portion 10 or the second intersection portion 11 on which the cutting edge is formed and the fifth intersection portion 13 receiving the cutting resistance can be reduced, the moment of the cutting resistance can be suppressed. Therefore, since the moment applied to the screw is also reduced, plastic deformation of the screw can be suppressed.

Furthermore, in the prior-art square-shaped cutting insert, in order to ensure the size required for the back support portion of the tool body, it was necessary to arrange the cutting inserts with some degree of a distance between them. In contrast, since such consideration is not needed in the embodiment, the distance between the cutting inserts in the peripheral direction can be reduced for arrangement. Therefore, when the sizes of the tool main bodies are the same, the number of cutting inserts that can be attached to the tool body can be increased as compared with the prior-art example, and more efficient cutting can be performed. Moreover, when the distance between the cutting inserts is set the same as the prior-art example, the chip pocket 23 can be formed larger than the prior-art example. Therefore, chip discharge efficiency can be improved.

When the extension of the first intersection portion 10 and the extension of the second intersection portion 11 intersect with each other at the angle α within a range of 75° or more and 150° or less on top view, the above-described effects can be favorably exerted. When the angle α is smaller than 75°, the fifth intersection portion 13 becomes too short and the cutting insert holding force lowers, while when the angle α is larger than 150°, the lateral width of the cutting insert 1 becomes too long and the size of the cutting insert 1 becomes large.

By providing the chamfered portion 15 on the connection portion between the first intersection portion 10 and the second intersection portion 11, a machined surface of the workpiece can be favorably finished. That is, by chamfering the corner portion between the first intersection portion 10 and the second intersection portion 11, possibility of damaging the machined surface of the workpiece during cutting can be reduced. Furthermore, it is possible to apply rounding or chamfering to the intersection portion between the upper face 2 or the lower face 3 and the second lateral side face 6 or the first lateral side face 8 in accordance with the material of the workpiece, the shape of the groove, machining conditions, and the like. As a result, the possibility of damaging the machined surface of the workpiece is reduced, and a favorable machined surface can be obtained.

Moreover, although the length of the cutting edge 18t, 18b, 19t, 19b in the cutting insert 1 has the same length as the cutting edge in the prior-art square-shaped cutting insert, the size (volume) of the cutting insert 1 is much less than that of the prior-art square-shaped cutting insert. Therefore, the raw material of the insert can be reduced, and a manufacturing cost of the insert can be kept considerably low.

### Second Embodiment

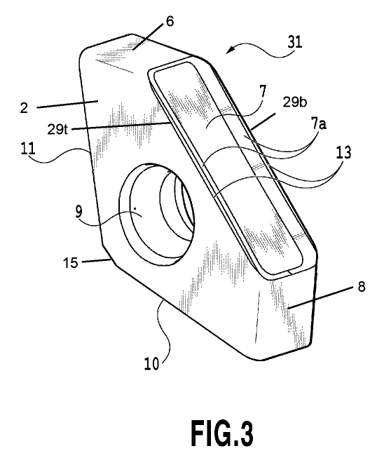

Subsequently, a second embodiment of the present invention will be described by referring to FIG. 3. In a cutting insert 31 of the second embodiment, explanation of the portions having the configuration similar to that of the cutting insert 1 in the first embodiment will be omitted.

As illustrated in FIG. 3, the second embodiment is configured such that, in addition to the first intersection portion 10 and the second intersection portion 11 on the upper and lower faces, the fifth intersection portion 13 in each of the upper face 2 and the lower face 3 is used as a cutting edge. As a result, the cutting edge of this embodiment has two cutting edges 19t, 18b for left hand, two cutting edges 18t, 19b for right hand, and two cutting edges 29t, 29b at the center, that is, six cutting edges in total. The fifth intersection portion 13 which is the cutting edge 29t, 29b may be subjected to honing. On the central side face 7 in contact with the fifth intersection portion 13 on the upper and lower faces, a third rake face 7a is formed, and so in this embodiment the central side face 7 is considered a central cutting side face 7. This third rake face 7a is formed so as to gradually incline toward the inside of the cutting insert 31 from the fifth intersection portion 13. On the central side face 7 on which the third rake face 7a is formed, a bottom portion where the height from the fifth intersection portion 13 is the lowest may be formed flat, may be formed of curved surfaces or may be formed of intersecting with inclined surfaces.

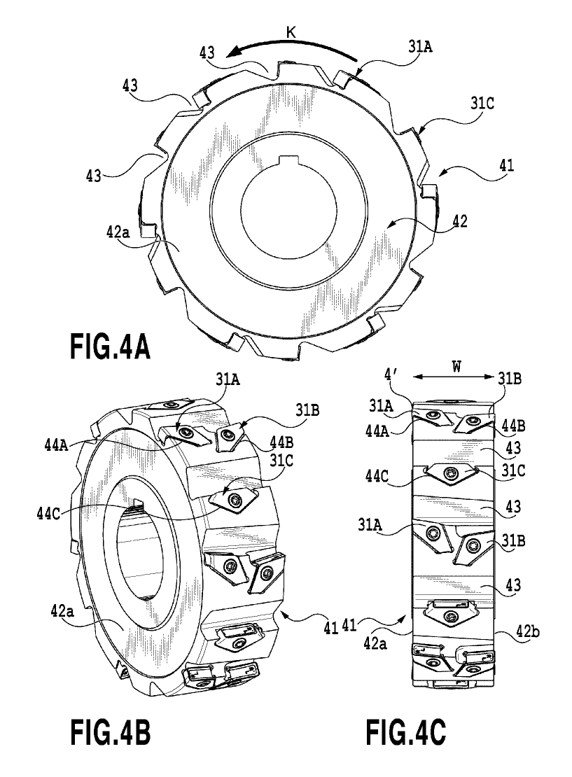

Next, a rotary cutting tool 41 to which the cutting insert 31 of the second embodiment is attached will be described by referring to FIGS. 4A-4C. Explanation of the portions having the same configuration as that of the rotary cutting tool explained in the first embodiment will be omitted.

FIGS. 4A to 4C illustrate the rotary cutting tool 41 to which the cutting insert 31 of the second embodiment is attached. In FIGS. 4A to 4C, a disk-shaped tool body 42 defines opposing first and second end faces 42a and 42b and an outer peripheral surface extending between the first and second end faces 42a and 42b. On the outer peripheral surface of the tool body 42, a plurality of insert seat portions 44A, 44B, and 44C are formed in the peripheral direction. For each of the plurality of insert seat portions 44A, 44B, and 44C, a chip pocket 43 is provided on the front side in the tool rotating direction (K). To the insert seat portions 44A, 44B, and 44C, cutting inserts 31A to 31C are attached, respectively. The cutting inserts 31A to 31C have the same structure as that of the cutting insert 31 explained in FIG. 3, but are given different reference numerals for convenience of explanation. There are shown the cutting insert 31A arranged for right hand, the cutting insert 31B arranged for left hand, and the cutting insert 31C arranged at the center part of the outer peripheral surface.

The insert seat portions 44A and 44B and the insert seat portion 44C are arranged alternately in the peripheral direction of the outer peripheral surface of the tool body 42. The seat portion 44A arranges the cutting insert 31A closer to the first end face 42a so that the cutting edge 18t of the first intersection portion 10 of the cutting insert 31A is used. The seat portion 44B arranges the cutting insert 31B closer to the second end face 42b so that the cutting edge 19t of the second intersection portion 11 of the cutting insert 31B is used. The seat portion 44C arranges the cutting insert 31C substantially at the center between the first and second end faces 42a and 42b so that the cutting edge 29t of the fifth intersection portion 13 of the cutting insert 31C is used.

Meanwhile, when the cutting edges on the lower face 3 of the cutting insert 31 is to be used, the seat portion 44A arranges the cutting insert 31A so that the cutting edge 19b of the second intersection portion 11 of the cutting insert 31A is used, and the seat portion 44B arranges the cutting insert 31B so that the cutting edge 18b of the first intersection portion 10 of the cutting insert 31B is used. The seat portion 44C arranges the cutting insert 31C so that the cutting edge 29b is used.

By arranging the cutting inserts 31A to 31C as above, the cutting edges can be arranged on the whole region in the width direction W of the groove to be machined. The two cutting inserts 31A and 31B forming a pair in the arrangement of right hand and left hand may have the respective cutting edges arranged at the same circumferential position in the rotating direction K of the tool body 42, or either one of the cutting edges may be arranged with a backward shift so that the operative cutting edge of one of the two cutting inserts 31A, 31B leads the other. If either one of the cutting edges is arranged with a shift, an additional chip pocket is provided in the shifted tool body 42.

The action/effect of the rotary cutting tool 41 to which the cutting insert 31 is attached will be described below. The same action/effect as those in the above-described first embodiment will be omitted.

In the second embodiment, in addition to the characteristics of the first embodiment, grooving with a wider width can be handled by the additional cutting insert 31C. That is, when a groove having a width wider than the combined length of the cutting edges 18t, 19t or cutting edges 18b, 19b at the first intersection portion 10 and the second intersection portion 11 is to be machined, another type of a cutting insert needs to be introduced in order to compensate for the shortage in the prior-art example. In contrast, in the embodiment, the shortage can be compensated for by using the cutting insert 31 having the same structure, through the use of the cutting edge 29t, 29b at the fifth intersection portion 13. Therefore, since the wider groove can be machined by repeatedly using the cutting insert 31 having the same structure, a cost rise can be suppressed, and tool management becomes easy. Furthermore, in this additional cutting insert 31C, since the two cutting side faces 4 and 5, which are on the rear side in the tool rotating direction K of the third cutting side face 7, form a V-shape, it is possible to reliably receive the holding force against the cutting resistance while dispersing it.

### Third Embodiment

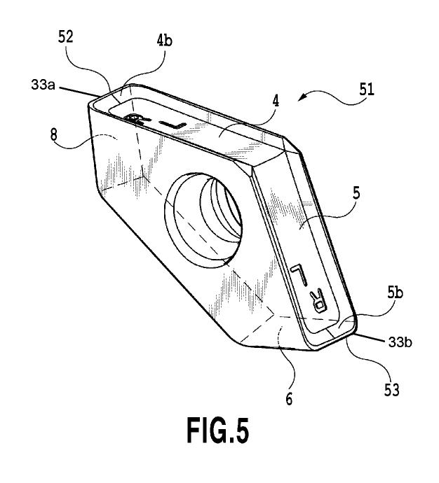

Next, a cutting insert 51 of a third embodiment will be described by referring to FIG. 5. In the cutting insert of the embodiment, explanation of the portions having the same configuration as that of the cutting insert in the first embodiment will be omitted.

As illustrated in FIG. 5, the embodiment is configured such that a first side-face intersection portion 52 between the first cutting side face 4 and the first lateral side face 8 and a second side-face intersection portion 53 between the second cutting side face 5 and the second lateral side face 6 are used as cutting edges 33a, 33b. A cutting edge is not formed on portions other than these side-face intersection portions 52 and 53. On the cutting side faces 4 and 5, the rake faces 4b and 5b are formed. These rake faces 4b and 5b are formed so as to gradually incline toward the inside of the cutting insert 51 from the side-face intersection portion. On the cutting side faces 4 and 5 on which the rake faces 4b and 5b are formed, the bottom portion may be formed of a flat surface, may be formed of a curved surface or may be formed of a plurality of intersecting inclined surfaces, and the side-face intersection portion on which the cutting edge 33a, 33b is formed may be subjected to honing. In the embodiment, the cutting edge 33a, 33b is formed on both the side-face intersection portions 52 and 53, but this is not limiting, and the cutting edge may be formed only on either one of them.

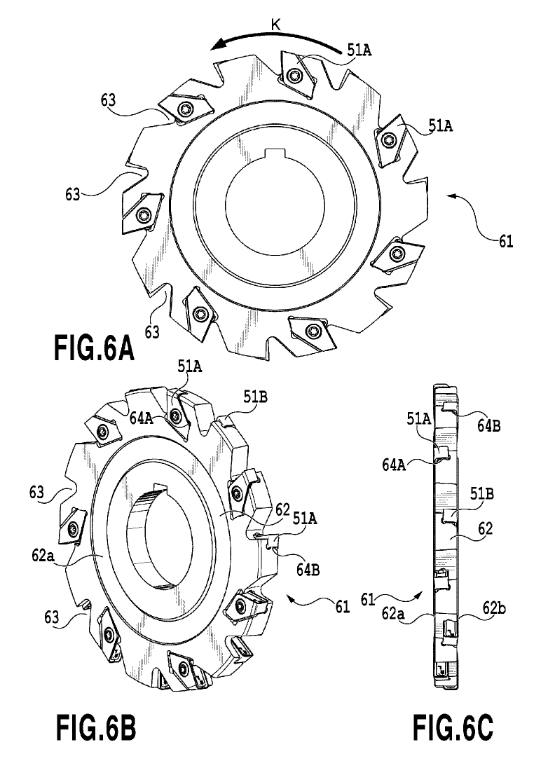

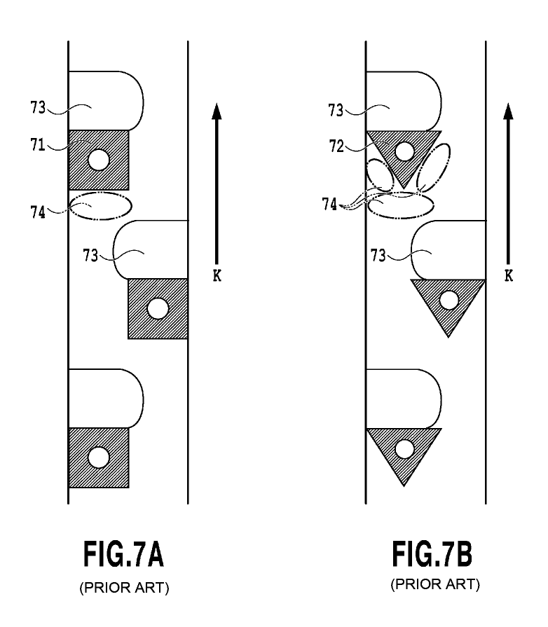

Next, a rotary cutting tool 61 to which the cutting insert 51 of the third embodiment is attached will be described by referring to FIG. 6. Explanation of the portions having the same configuration as that of the rotary cutting tool explained in the first embodiment will be omitted.

FIG. 6 illustrate a rotary cutting tool 61 to which the cutting insert 51 of the third embodiment is attached. A disk-shaped tool body 62 of the rotary cutting tool 61 defines opposing first and second end faces 62a and 62b and an outer peripheral surface extending between the first and second end faces 62a and 62b. On the outer peripheral surface of the tool body 62, a plurality of insert seat portions 64A and 64B are formed in the peripheral direction. The insert seat portion 64A and the insert seat portion 64B are provided alternately in the peripheral direction of the outer peripheral surface. In each of the plurality of insert seat portions 64, a chip pocket 63 is provided on the front side in the tool rotating direction (K). In each of the insert seat portions 64A and 64B, cutting inserts 51A and 51B are attached, respectively. Meanwhile, the cutting inserts 51A and 51B have the same structure as that of the cutting insert 51 explained in FIG. 5, but are given different reference numerals for convenience of explanation.

The seat portion 64A arranges the cutting insert 51A closer to the first end face 62a so that the cutting edge 33a, 33b of either one of the first and second side-face intersection portions 52 and 53 of the cutting insert 51A is used and the upper face 2 or the lower face 3 of the cutting insert 51A is exposed to the outside from the first end face 62a. The seat portion 64B arranges the cutting insert 51B closer to the second end face 62b so that the cutting edge 33a, 33b of either one of the first and second side-face intersection portions 52 and 53 of the cutting insert 51B is used and the upper face 2 or the lower face 3 of the cutting insert 51B is exposed to the outside from the second end face 62b. As a result, the first and second side-face intersection portions 52 and 53 are involved in cutting. In this rotary cutting tool 61, unlike the above-described rotary cutting tools 21 and 41, the cutting insert 51 is screwed from any end face sides of the tool body 62.

Next, the action/effect of the rotary cutting tool 61 to which the cutting insert 51 of the third embodiment is attached will be described below. The same action/effect as those of the above-described first embodiment will be omitted.

In the embodiment, by using the side-face intersection portions 52 and 53 as the cutting edges, grooving having a smaller width can be handled. As a result, machining of such small groove that cannot be handled by the first intersection portion 10 and the second intersection portion 11 can be handled. Also in the embodiment, since the back support portion is ensured similarly to the first embodiment, fixability of the cutting insert can be drastically improved.

To the cutting inserts 31 and 51 of the above-described second and third embodiments, various modifications made in the cutting insert 1 in the first embodiment can be similarly applied.

Although typical embodiments of the present invention have been described, the present invention is capable of various modifications, and replacement and modifications are possible as long as the present invention does not depart from the spirit and scope defined by claims of the present application.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A plate-like cutting insert comprising:
an upper face having a substantially polygonal outer shape;
a lower face opposite to the upper face;
a plurality of side faces extending between the upper face and the lower face; and
a mounting hole penetrating from the upper face to the lower face, wherein:
the upper face comprises at least five intersection portions intersecting with the plurality of side faces;
a first intersection portion and a second intersection portion are arranged at positions adjacent to each other;
a third intersection portion is arranged at a position adjacent to the first intersection portion;
a fourth intersection portion is arranged at a position adjacent to the second intersection portion;
the third and fourth intersection portions comprise lengths shorter than the first and second intersection portions, respectively;
on the first and second intersection portions, a cutting edge is formed, respectively;
on the plurality of side faces, a rake face is formed on the side face corresponding to the first and second intersection portions, respectively; and
on the upper face, a flank for forming a cutting edge is formed.

2. The cutting insert according to claim 1, wherein:
a fifth intersection portion is arranged at a position adjacent to at least one of the third and the fourth intersection portions, and a cutting edge is formed on the fifth intersection portion;
a rake face is formed on a side face corresponding to the fifth intersection portion; and
a flank for forming the cutting edge of the fifth intersection portion is formed on the upper face.

3. The cutting insert according to claim 1, wherein
the first intersection portion and the second intersection portion are arranged so that extensions thereof intersect with each other at an angle of 75° or more and 150° or less, in a top view of the upper face.

4. The cutting insert according to claim 1, further comprising
a chamfer portion formed on a connection portion connecting the first intersection portion and the second intersection portion.

5. The cutting insert according to claim 1, wherein
the upper face has a substantially pentagonal outer shape; and
the fifth intersection portion is arranged at a position adjacent to both the third and fourth intersection portions.

6. A plate-like cutting insert comprising:
an upper face having a substantially polygonal outer shape, a lower face opposite to the upper face;
a plurality of side faces extending between the upper face and the lower face; and
a mounting hole penetrating from the upper face to the lower face, wherein:
the upper face comprises at least five intersection portions intersecting with the plurality of side faces;
a first intersection portion and a second intersection portion are arranged at positions adjacent to each other;
a third intersection portion is arranged at a position adjacent to the first intersection portion;
a fourth intersection portion is arranged at a position adjacent to the second intersection portion;
the third and fourth intersection portions have lengths shorter than the first and second intersection portions, respectively;
a cutting edge is formed on at least one of:
a first side-face intersection portion between a first side face corresponding to the first intersection portion and a third side face corresponding to the third intersection portion, and
a second side-face intersection portion between a second side face corresponding to the second intersection portion and a fourth side face corresponding to the fourth intersection portion; and
a flank for forming the cutting edge is formed on at least one of the third and fourth side faces.

7. An indexable rotary cutting tool comprising:
a disk-shaped tool body defining opposing first and second end faces and an outer peripheral surface extending between the first and second end faces;
a plurality of insert seat portions formed along a peripheral direction of the outer peripheral surface;
a plurality of chip pockets provided on a front side of a tool rotating direction with respect to each of the plurality of insert seat portions; and
a cutting insert according to claim 1 attached to each of the plurality of insert seat portions, wherein
the cutting edge of the first intersection portion and the cutting edge of the second intersection portion of the cutting insert are used alternately in the peripheral direction of the tool body.

8. The indexable rotary cutting tool according to claim 7, wherein
the plurality of inserts are capable of cutting a slot with a width substantially corresponding to a width of the outer peripheral surface of the tool body by collaboration between the cutting edge of the first intersection portion and the cutting edge of the second intersection portion of the cutting insert.

9. An indexable rotary cutting tool comprising:
a disk-shaped tool body defining opposing first and second end faces and an outer peripheral surface extending between the first and second end faces;
a plurality of insert seat portions formed along a peripheral direction of the outer peripheral surface;
a plurality of chip pockets provided on a front side of the tool rotating direction with respect to each of the plurality of insert seat portions; and
a cutting insert according to claim 2 attached to each of the plurality of insert seat portions, wherein
the plurality of insert seat portions comprises first and second seat portions for attaching first and second cutting inserts and a third seat portion for attaching a third cutting insert;
the first and second seat portions, and the third seat portion, are arranged alternately in the peripheral direction of the outer peripheral surface;
the first seat portion arranges the first cutting insert closer to the first end face so that the cutting edge of the first intersection portion of the first cutting insert is used;
the second seat portion arranges the second cutting insert closer to the second end face so that the cutting edge of the second intersection portion of the second cutting insert is used; and
the third seat portion arranges the third cutting insert substantially at the center between the first and second end faces so that a cutting edge at the fifth intersection portion of the third cutting insert is used.

10. An indexable rotary cutting tool comprising:
a disk-shaped tool body defining opposing first and second end faces and an outer peripheral surface extending between the first and second end faces;
a plurality of insert seat portions formed along a peripheral direction of the outer peripheral surface;
a plurality of chip pockets provided on a front side of the tool rotating direction with respect to each of the plurality of insert seat portions; and
a cutting insert according to claim 6 attached to each of the plurality of insert seat portions, wherein
the plurality of insert seat portions include a first seat portion for attaching a first cutting insert and a second seat portion for attaching a second cutting insert;
the first seat portion and the second seat portion are provided alternately in the peripheral direction of the outer peripheral surface;
the first seat portion arranges the first cutting insert closer to the first end face so that the cutting edge of the first side-face intersection portion of the first cutting insert is used and the upper face of the first cutting insert is exposed to the outside from the first end face; and
the second seat portion arranges the second cutting insert closer to the second end face so that the cutting edge of the second side-face intersection portion of the second cutting insert is used and the upper face of the second cutting insert is exposed to the outside from the second end face.
